(19) United States
(12) Patent Application Publication
(10) Pub. No.: US 2019/0079860 A1
(43) Pub. Date: Mar. 14, 2019

(54) MEMORY CONTROLLER, MEMORY SYSTEM HAVING THE SAME, AND OPERATING METHOD THEREOF

(71) Applicant: SK hynix Inc., Gyeonggi-do (KR)

(72) Inventor: Min Kee KIM, Sejong-si (KR)

(21) Appl. No.: 15/951,687

(22) Filed: Apr. 12, 2018

(30) Foreign Application Priority Data
Sep. 12, 2017 (KR) 10-2017-0116721

(51) Int. Cl. G06F 12/02; G06F 13/16; G06F 3/06

(52) U.S. Cl. CPC G06F 12/0246; G06F 12/0292; G06F 13/1673; G06F 2212/7201; G06F 3/0659; G06F 3/0661; G06F 3/0656

(57) ABSTRACT

Provided herein may be a memory controller, a memory system having the memory controller, and a method of operating the memory system. The memory controller may include: a host interface configured to receive an external read command and a logical address from a host, and output read data to the host; an internal memory configured to output a physical address corresponding to the logical address; a control processor configured to convert the external read command into an internal read command, and control a read operation; and a memory interface configured to transmit the internal read address and the physical address to a memory device, and transmit read data received from the memory device to the host interface.

### CROSS-REFERENCE TO RELATED APPLICATION

The present application claims priority under 35 U.S.C. § 119(a) to Korean patent application number 10-2017-0116721 filed on Sep. 12, 2017, the entire disclosure of which is incorporated herein by reference.

### BACKGROUND

### 1. Field of Invention

Various embodiments of the present disclosure generally relate to a memory controller, a memory system having the memory controller, and a method of operating the memory system. Particularly, the embodiments relate to a memory controller capable of reducing the read operation time, a memory system having the memory controller, and a method of operating the memory system.

### 2. Description of Related Art

A memory system may include a storage device and a memory controller.

The storage device may include a plurality of memory devices. The memory devices may store data or output the stored data. For example, the memory devices may consist of volatile memory devices in which stored data is lost when power is turned off, or non-volatile memory devices in which stored data is retained even when power supply is interrupted.

The memory controller may control data communication between a host and the storage device.

The host may communicate with the memory device through the memory controller using an interface protocol such as a peripheral component interconnect-express (PCI-E), an advanced technology attachment (ATA), an serial ATA (SATA), a parallel ATA (PATA) or an serial attached SCSI (SAS). The interface protocol provided for the purpose of data communication between the host and the memory system is not limited to the foregoing examples, and it may include various interface protocols such as a universal serial bus (USB), a multi-media card (MMC), an enhanced small disk interface (ESDI), and integrated drive electronics (IDE).

### SUMMARY

Various embodiments of the present disclosure are directed to a memory controller capable of reducing the read operation time and increasing internal memory capacity, a memory system having the memory controller, and a method of operating the memory system.

An embodiment of the present disclosure may provide for a memory controller including: a host interface configured to receive an external read command and a logical address from a host, and output read data to the host; an internal memory configured to output a physical address corresponding to the logical address; a control processor configured to convert the external read command into an internal read command, and control a read operation; and a memory interface configured to transmit the internal read address and the physical address to a memory device, and transmit read data received from the memory device to the host interface.

An embodiment of the present disclosure may provide for a memory system including: a memory device configured to store data; and a memory controller configured to read, during a read operation, data stored in the memory device and output the read data to a host without temporarily storing the read data in the memory system.

An embodiment of the present disclosure may provide for a method of operating a memory system, including: receiving a read request from a host; controlling a memory device to perform a read operation in response to the read request; receiving read data from the memory device; and directly outputting the read data to the host without storing the read data in the memory system.

An operating method of a memory controller, the method comprising: buffering a data into a buffer in response to a program command; controlling a memory device to program the buffered data; controlling the memory device to read data in response to a read command; and transferring the read data from the memory device to an external device without an intervention of the buffer.

### BRIEF DESCRIPTION OF THE DRAWINGS

FIG. 1 is a diagram illustrating a memory system in accordance with an embodiment of the present disclosure.

FIG. 2 is a diagram illustrating in detail a memory device of FIG. 1.

FIG. 3 is a diagram illustrating a memory cell array of FIG. 2.

FIG. 4 is a circuit diagram illustrating a memory block of FIG. 3.

FIG. 5 is a diagram illustrating an embodiment in which the memory block of FIG. 3 has a three-dimensional configuration.

FIG. 6 is a diagram illustrating an embodiment in which the memory block of FIG. 3 has a three-dimensional configuration.

FIG. 7 is a flowchart illustrating a program operation method of the memory system in accordance with an embodiment of the present disclosure.

FIG. 8 is a diagram illustrating the sequence of the program operation of FIG. 7.

FIG. 9 is a flowchart illustrating a read operation method of the memory system in accordance with an embodiment of the present disclosure.

FIG. 10 is a diagram illustrating the sequence of the read operation of FIG. 9.

FIG. 11 is a diagram illustrating a memory system including a memory controller shown in FIG. 1.

FIG. 12 is a diagram illustrating a memory system including the memory controller shown in FIG. 1.

FIG. 13 is a diagram illustrating a memory system including the memory controller shown in FIG. 1.

FIG. 14 is a diagram illustrating memory system including the memory controller shown in FIG. 1.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present.

Hereinafter, embodiments will be described with reference to the accompanying drawings. Embodiments are described herein with reference to cross-sectional illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present disclosure. Furthermore, ‘and/or’ may include any one of or a combination of the components mentioned.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

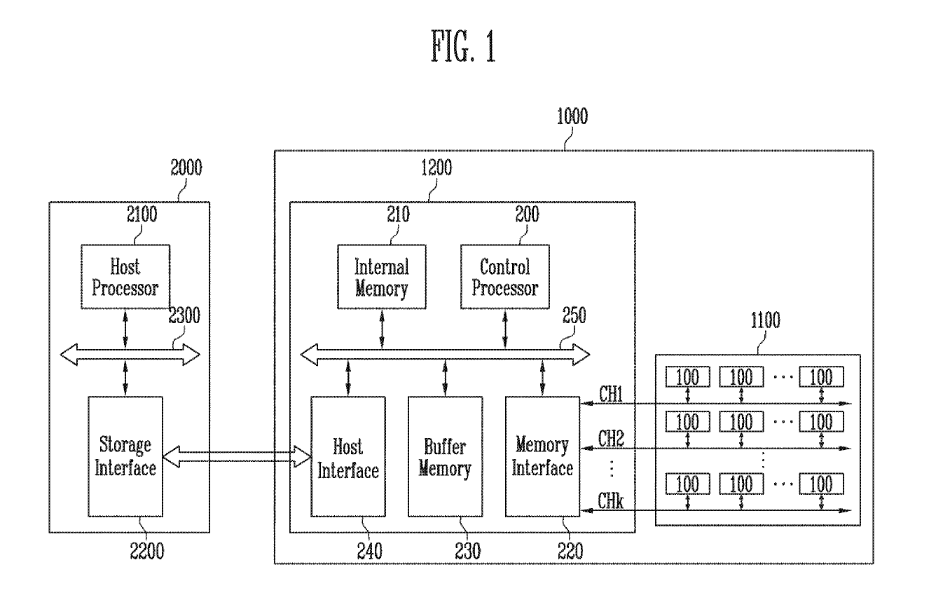

FIG. 1 is a diagram illustrating a memory system 1000 in accordance with an embodiment of the present disclosure.

Referring to FIG. 1, the memory system 1000 may include a storage device 1100 configured to store data, and a memory controller 1200 configured to communicate between the storage device 1100 and a host 2000.

The storage device 1100 may include a plurality of memory devices 100. For example, the memory devices 100 may be formed of volatile memory devices in which stored data is lost when power is turned off, or non-volatile memory devices in which stored data is retained even when power supply is interrupted. In FIG. 1, the memory devices 100 formed of non-volatile memory devices are illustrated as an embodiment. For example, each non-volatile memory device may be a flash memory device.

The memory devices 100 may be coupled to a plurality of channels CH1 to CHk. For instance, each of the first to k-th channels CH1 to CHk may be coupled to a plurality of memory devices 100.

The memory controller 1200 may include a control processor 200, an internal memory 210, a memory interface 220, a buffer memory 230, and a host interface 240.

The control processor 200 may perform various operations for controlling the storage device 1100 or may generate a command and an address. For example, the control processor 200 may generate a status check command for a status check operation and check the status of the storage device 1100. Depending on the result of the check, the control processor 200 may generate a command for controlling the storage device 1100.

The internal memory 210 may store various information needed for the operation of the memory controller 1200. For example, the internal memory 210 may include logical and physical address map tables. According to the address map tables, if a logical address is inputted to the internal memory 210, a physical address corresponding to the inputted logical address may be outputted. If a physical address is inputted to the internal memory 210, a logical address corresponding to the inputted physical address may be outputted. For example, a logical address may be inputted from the host 200 to the internal memory 210. A physical address may be inputted from the storage device 1100 to the internal memory 210. The internal memory 210 may be formed of at least one or more of a random access memory (RAM), a dynamic RAM (DRAM), a static RAM (SRAM), a cache, and a tightly coupled memory (TCM).

The memory interface 220 may exchange a command, an address, data, etc. between the memory controller 1200 and the storage device 1100. For example, the memory interface 220 may transmit a command, an address, data, etc. to the memory devices 100 through the first to k-th channels CH1 to CHk, and receive data, etc. from the memory devices 100 through the first to k-th channels CH1 to CHk. Here, the command may be an internal command, and the address may be a logical address.

The buffer memory 230 may temporarily store data during an operation of the memory system 1000. For example, during a program operation, the buffer memory 230 may temporarily store original program data until a program operation of a selected memory device 100 has passed. In an embodiment of the present disclosure, during a read operation, the buffer memory 230 may not temporarily store data read from the memory devices 100. The buffer memory 230 may be formed of an SRAM or a DRAM.

The host interface 240 may exchange a command, an address, data, etc. between the memory controller 1200 and the host 2000. For example, the host interface 240 may receive a command, an address, data, etc. from the host 2000 and transmit data, etc. to the host 2000. Here, the command may be an external command, and the address may be a physical address.

The control processor 200, the internal memory 210, the memory interface 220, the buffer memory 230, and the host interface 240 may communicate with each other through a bus 250.

The host 2000 may include a host processor 2100 and a storage interface 2200. The host processor 2100 and the storage interface 2200 may communicate with each other through a bus 2300.

The host processor 2100 may generate a program request for controlling a program operation of the memory system 1000 or a read request for controlling a read operation. For example, the program request may include a physical address and an external program command to be transmitted to the memory system 1000. For example, the read request may include a physical address and an external read command to be transmitted to the memory system 1000. In addition, the host processor 2100 may control various operation requests such as an erase request, and an operation of transmitting firmware and so forth to the memory system 1000.

The storage interface 2200 may use, to communicate with the memory system 1000, an interface protocol such as a peripheral component interconnect-express (PCIe), an advanced technology attachment (ATA), a serial ATA (SATA), a parallel ATA (DATA), a serial attached SCSI (SAS), or a non-volatile memory express (NVMe). The storage interface 2200 is not limited to the foregoing examples, and it may include various interface protocols such as a universal serial bus (USB), a multi-media card (MMC), an enhanced small disk interface (ESDI), and integrated drive electronics (IDE).

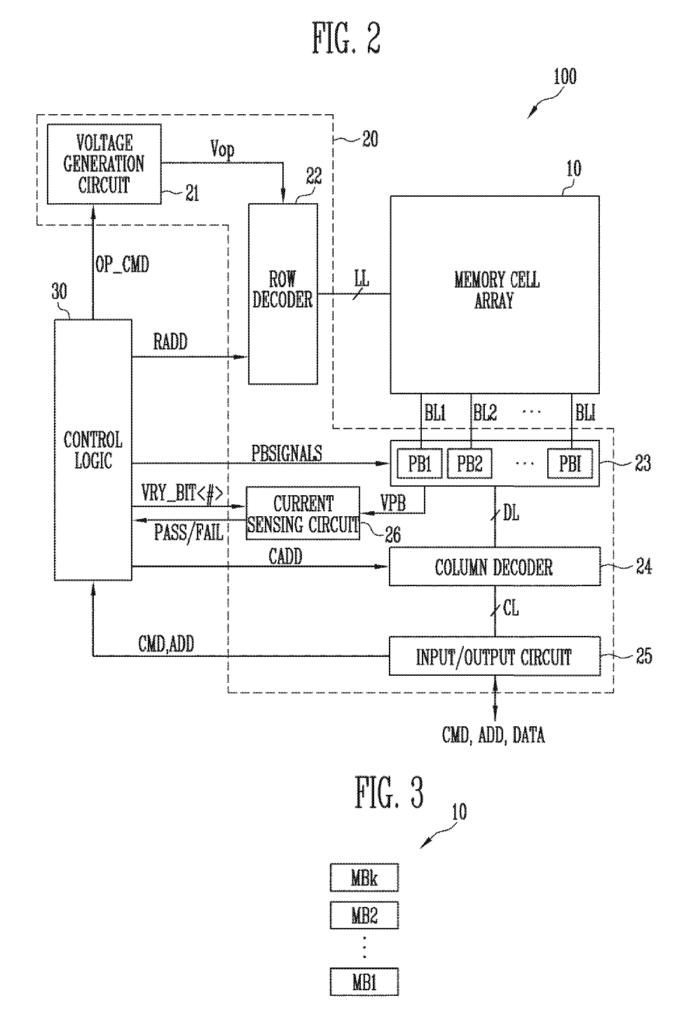

FIG. 2 is a diagram illustrating in detail a memory device 100 of FIG. 1.

Referring to FIG. 2, the memory device 100 may include a memory cell array 10 configured to store data. The memory device 100 may include peripheral circuits 20 configured to perform a program operation for storing data in the memory cell array 10, a read operation for outputting the stored data, and an erase operation for erasing the stored data. The memory device 100 may include a control logic 30 configured to control the peripheral circuits 20 under control of the to memory controller (1200 of FIG. 1).

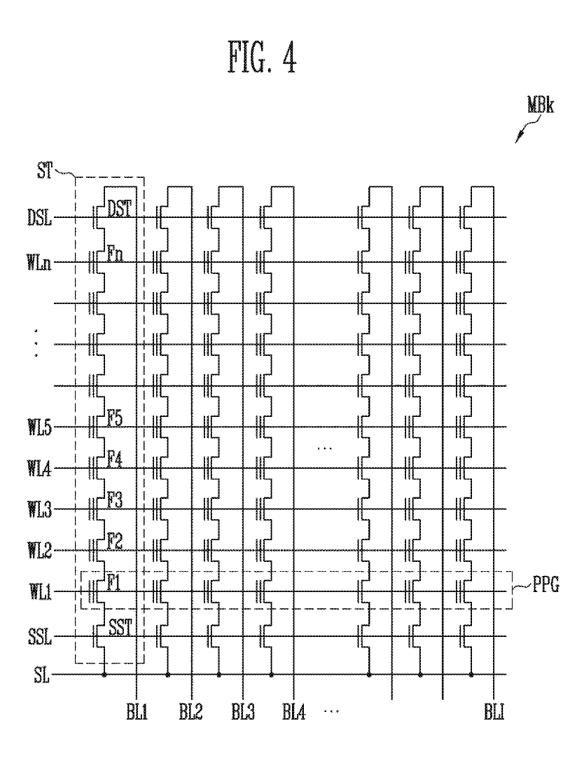

The memory cell array 10 may include a plurality of memory blocks (shown in FIG. 3). User data and various information needed for operations of the memory device 100 may be stored in the memory blocks. The memory blocks may be embodied in a two- or three-dimensional structure.

The peripheral circuits 20 may be configured to perform a program operation, a read operation, or an erase operation under control of the control logic 30. For example, the peripheral circuits 20 may include a voltage generation circuit 21, a row decoder 22, a page buffer group 23, a column decoder 24, an input/output circuit 25, and a current sensing circuit 26.

The voltage generation circuit 21 may generate various operating voltages Vop to be used for the program operation, the read operation, or the erase operation in response to an operating signal OP_CMD. For example, the voltage generation circuit 21 may generate a program voltage, a verify voltage, a pass voltage, a compensation program voltage, a read voltage, an erase voltage, a turn-on voltage, etc. under control of the control logic 30.

The row decoder 22 may transmit, in response to a row address RADD, operating voltages Vop to local lines LL coupled to a selected one of the memory blocks of the memory cell array 10. The local lines LL may include local word lines, local drain select lines, and local source select lines. In addition, the local lines LL may include various lines such as a source line coupled to the memory block.

The page buffer group 23 may be coupled to bit lines BL1 to BLI coupled to the memory blocks of the memory cell array 10. The page buffer group 23 may include a plurality of page buffers PB1 to PBI coupled to the bit lines BL1 to BLI. The page buffers PB1 to PBI may operate in response to page buffer control signals PBSIGNALS. For instance, the page buffers PB1 to PBI may temporarily store data received through the bit lines BL1 to BLI or sense voltages or currents of the bit lines BL1 to BLI during a read operation or a verify operation.

The column decoder 24 may transmit data between the input/output circuit 25 and the page buffer group 23 in response to a column address CADD. For example, the column decoder 24 may exchange data with the page buffers PB through data lines DL or exchange data with the input/output circuit 25 through column lines CL.

The input/output circuit 25 may transmit a command CMD or an address ADD received from the memory controller (1120 of FIG. 1) to the control logic 30, or exchange data DATA with the column decoder 24.

During a read operation or a verify operation, the current sensing circuit 26 may generate a reference current in response to an enable bit VRY_BIT<#>, and may compare a sensing voltage VPB received from the page buffer group 23 to a reference voltage generated by the reference current and output a pass signal PASS or a fail signal FAIL.

The control logic 30 may output an operating signal OP_CMD, a row address RADD, page buffer control signals PBSIGNALS, and an enable bit VRY_BIT<#> in response to a command CMD and an address ADD and thus control the peripheral circuits 20. Furthermore, the control logic 30 may determine whether a verify operation has passed or failed, in response to a pass signal PASS or a fail signal FAIL.

FIG. 3 is a diagram illustrating the memory cell array 10 of FIG. 2.

Referring to FIG. 3, the memory cell array 10 may include a plurality of memory blocks MB1 to MBk. Each of the memory blocks MB1 to MBk may include a plurality of memory cells configured to store data and be embodied in a two- or three-dimensional structure.

FIG. 4 is a circuit diagram illustrating a memory block of FIG. 3.

Since each of the memory blocks MB1 to MBk illustrated in FIG. 3 may have the same configuration, any one memory block MBk among the plurality of memory blocks MBI to MBk will be described as an example with reference to FIG. 4.

The memory block MBk may include a plurality of cell strings ST coupled between the bit lines BL1 to BLI and the source line SL. For example, the cell strings ST may be coupled to the respective bit lines BL1 to BLI and coupled in common to the source line SL. Each of the cell strings ST have a similar configuration, so the cell string ST that is coupled to the first bit line BL1 will be described as an example.

Each cell string ST may include a source select transistor SST, first to n-th memory cells F1 to Fn (where n is a positive integer), and a drain select transistor DST, which are coupled in series to each other between the source line SL and the first bit line BL1. The number of source and drain select transistors SST and DST is not limited to those shown in FIG. 4. The source select transistor SST may be coupled between the source line SL and the first memory cell F1. The first to n-th memory cells F1 to Fn may be coupled in series between the source select transistor SST and the drain select transistor DST. The drain select transistor DST may be coupled between the nth memory cell Fn and the first bit line BL1. Although not shown in FIG. 4, dummy cells may be further coupled between the memory cells F1 to Fn or between the source select transistor SST and the drain select transistor DST.

Included in different cell strings ST, gates of the source select transistors SST may be coupled to a source select line SSL, gates of the first to nth memory cells F1 to Fn may be respectively coupled to first to n-th word lines word lines WL1 to WLn, and gates of the drain select transistors DST may be coupled to a drain select line DSL. A group of memory cells coupled to each of the word lines WL1 to WLn is called a page PPG. For example, among the memory cells F1 to Fn included in different cell strings ST, a group of first memory cells F1 coupled to the first word lines WL1 may form a single page PPG. A program operation or a read operation may be performed on a page (PPG) basis.

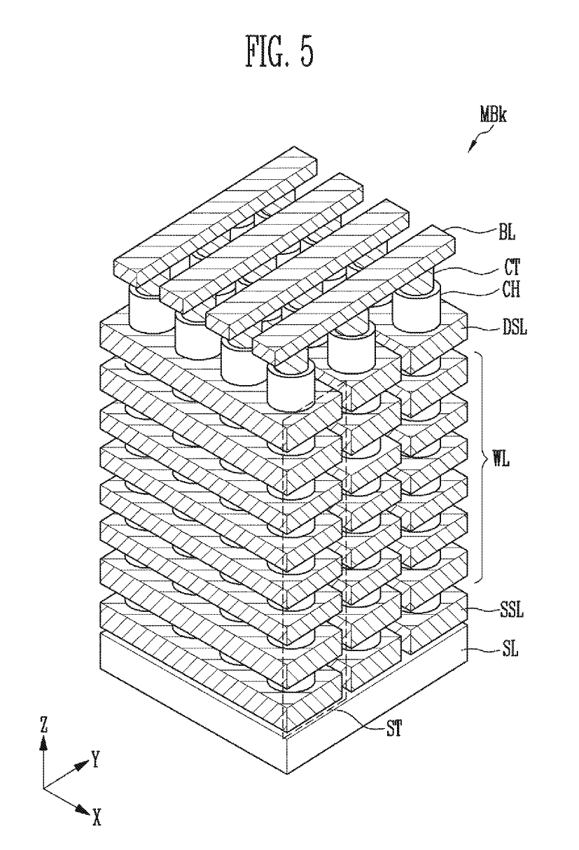

FIG. 5 is a diagram illustrating an embodiment in which the memory block MBk of FIG. 3 has a three-dimensional structure.

Referring to FIG. 5, the memory block MBk having a three-dimensional structure may be formed in a vertical (Z-directional) I shape on a substrate, and include a plurality of cell strings ST arranged between the bit lines BL and the source line SL A well may be formed in lieu of the source line SL. This structure may be called a bit cost scalable (BiCS) structure. For example, when the source line SL is horizontally formed on the substrate, the cell strings ST having a BiCS structure may be formed over the source line SL in the vertical direction (Z-axis direction).

In more detail, the cell strings ST may be arranged in a first direction (an X-axis direction) and a second direction (a Y-axis direction). The cell strings ST may include source select lines SSL, word lines WL, and drain select lines DSL which are stacked at positions spaced apart from each other. The number of source select lines SSL, the number of word lines WL, and the number of drain select lines DSL are not limited to those shown in the drawing, and may change depending on the structure of the memory device 100. The cell strings ST may include vertical channel layers CH which vertically pass through the source select lines SSL, the word lines WL and the drain select lines DSL, and bit lines BL which come into contact with upper ends of the vertical channel layers CH protruding upward from the drain select lines DSL and extend in the second direction (Y-axis direction). The memory cells may be formed between the word lines WL and the vertical channel layers CH. Contact plugs CT may be further formed between the bit lines BL and the vertical channel layers CH.

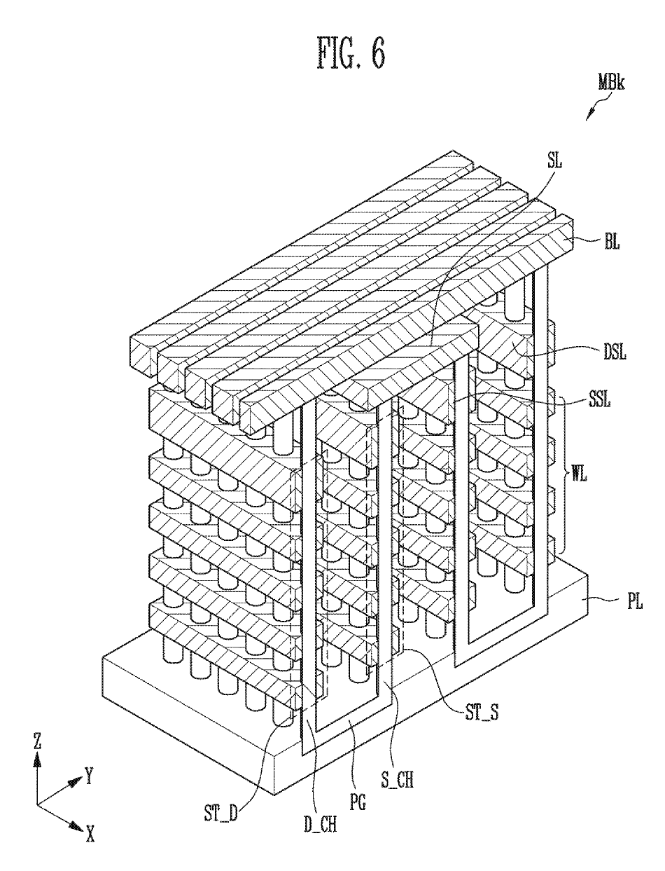

FIG. 6 is a diagram illustrating an embodiment in which the memory block MBk of FIG. 3 has a three-dimensional configuration.

Referring to FIG. 6, the memory block MBk having a three-dimensional structure may be formed in a vertical (Z-directional) U shape on a substrate, and include source strings ST_S and drain strings ST_D which are coupled between the bit lines BL and the source line SL and make pairs. Each source string ST_S and the corresponding drain string ST_D may be coupled to each other through a pipe gate PG to form a U shape. The pipe gate PG may be formed in a pipe line PL. In more detail, the source strings ST_S may be vertically formed between the source line SL and the pipe line PL. The drain strings ST_D may be vertically formed between the bit lines BL and the pipe line PL. This structure may be called a pipe-shaped bit cost scalable (P-BiCS) structure.

In more detail, the drain strings ST_D and the source strings ST_S may be arranged in a first direction (an X-axis direction) and a second direction (a Y-axis direction). The drain strings ST_D and the source strings ST_S may be alternately arranged in the second direction (Y-axis direction). The drain strings ST_D may include word lines WL and a drain select line DSL which are stacked at positions spaced apart from each other, and vertical drain channel layers D_CH which vertically pass through the word lines WL and the drain select line DSL. The source strings ST_S may include word lines WL and a source select line SSL which are stacked at positions spaced apart from each other, and vertical source channel layers S_CH which vertically pass through the word lines to WL and the source select line SSL. The vertical drain channel layers D_CH and the vertical source channel layers S_CH may be coupled to each other by the pipe gate PG in the pipe line PL. The bit lines BL may come into contact with upper ends of the vertical drain channel layers D_CH that protrude upward from the drain select line DSL, and may extend in the second direction (Y-axis direction).

The memory blocks MBk may be embodied in various structures including the structures described with reference to FIGS. 4 to 6.

FIG. 7 is a flowchart illustrating a program operation method of the memory system in accordance with an embodiment of the present disclosure. In describing the program operation method of the memory system, references will be made to FIGS. 1 to 6.

Referring to FIG. 7, when receiving a program request from the host, the memory system may perform a program operation. For example, during the program operation, the host may transmit an external program command, a logical address, and data to the memory system, at step S71. Here, the external program command, the logical address, and the data may be received through the host interface 240 of the memory system.

When a program request is received from the host, data included in the program request may be temporarily stored in the buffer memory 230 of the memory controller 1200, at step S72. For example, when a program request is received to the host interface 240, the controller processor 200 may perform a control operation such that data transmitted to the host interface 240 is transmitted to the buffer memory 230. The data that is temporarily stored in the buffer memory 230 may remain in the buffer memory 230 until a program operation of corresponding data on a selected memory block is completed. If the program operation of the corresponding data has failed, the program operation may be re-performed using the data that is temporarily stored in the buffer memory 230.

The logical address included in the program request may be converted into a physical address in the internal memory 210 of the memory controller 1200, at step S73. For example, when the host transmits the logical address to the memory system, the memory system may autonomously designate an address on which a program operation is to be performed, and program data on a memory device corresponding to the designated address. Here, the designated address may refer to a physical address. For this operation, mapping tables in which information about logical addresses and physical addresses is stored may be included in the internal memory 210 of the memory controller 1200. For example, a table for converting a logical address into a physical address and a table for converting a physical address into a logical address may be stored in the internal memory 210. The steps S72 and S73 described above may be reversed in order.

When step S72 and step S73 have been completed, the control processor 200 of the memory controller 1200 may convert the external program command that has been received from the host into an internal program command to be used in the memory system, and transmit the internal program command, the physical address, and data to the memory device 100 through the memory interface 220, at step S74. The memory device 100 may be a memory device selected in response to the physical address. The selected memory device 100 may perform the program operation in response to the internal program command, the physical address, and the data.

The sequence of the operation steps S71 to S74 of the memory controller 1200 will be described below with reference to the drawing illustrating the memory system.

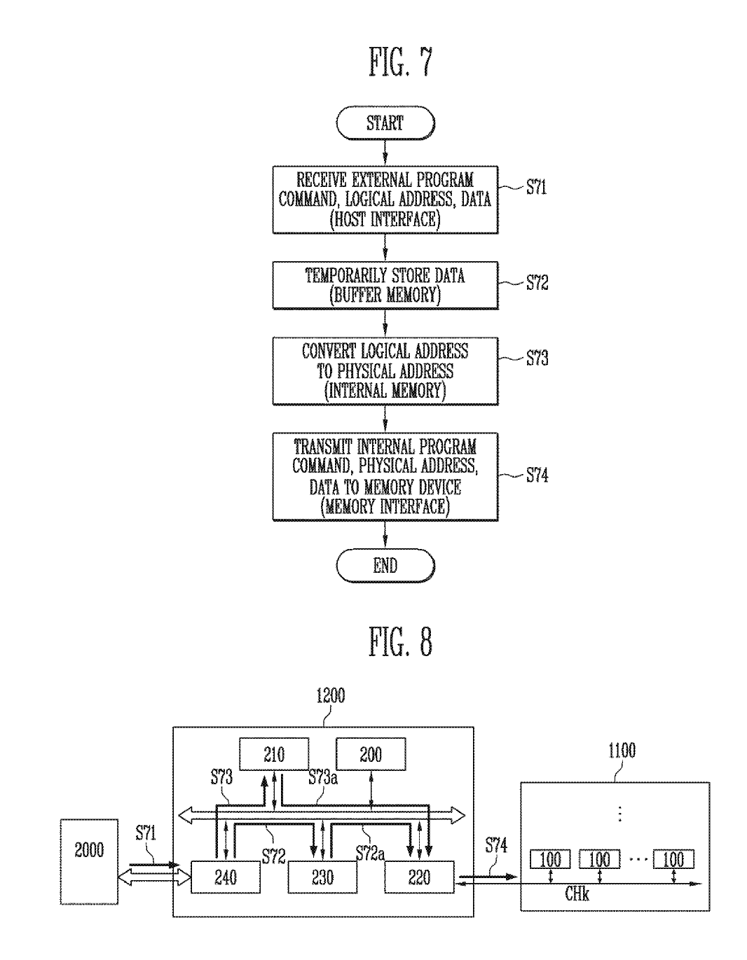

FIG. 8 is a diagram illustrating the sequence of the program operation of FIG. 7.

Referring to FIGS. 7 and 8, the host 2000 may apply a program request to the memory controller 1200 of the memory system 1000 at step S71. For example, the program request may include an external program command, a logical address, and data. In other words, the external program command, the logical address, and the data may be transmitted to the host interface 240 of the memory controller 1200.

When the program request is received from the host 2000, the data included in the program request may be transmitted to the buffer memory 230 through the host interface 240 and temporarily stored in the buffer memory 230 at step S72.

The logical address included in the program request may be transmitted to the internal memory 210 through the host interface 240 and converted into a physical address at step S73. For example, when the host 2000 transmits the logical address to the memory controller 1200, the memory controller 1200 may autonomously designate an address depending on the status of the memory devices 100 and transmit the data to a memory device 100 corresponding to the designated address. Here, the designated address may be a physical address. The steps S72 and S73 described above may be reversed in order.

When the physical address and the data temporarily stored in the buffer memory 230 are transmitted to the memory interface 220 at steps S73a and S72a, and the internal program command is also transmitted to the memory interface 220, the internal program command, the physical address, and the data may be transmitted to the selected one of the memory devices 100 through the memory interface 220 at step S74. The selected memory device 100 may perform the program operation in response to the internal program command, the physical address, and the data.

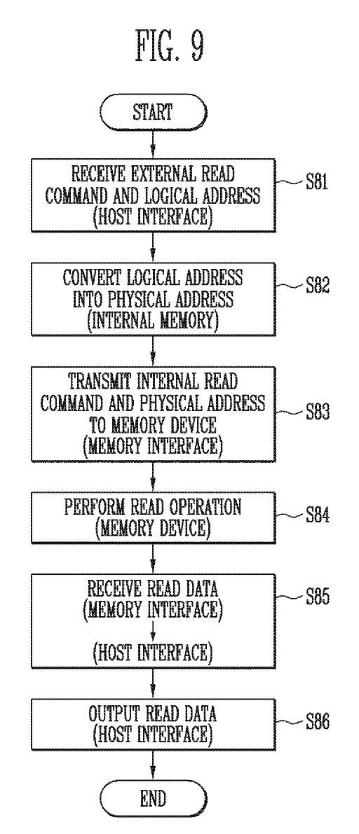

FIG. 9 is a flowchart illustrating a read operation method of the memory system in accordance with an embodiment of the present disclosure. In describing the read operation method of the memory system, references will be made to FIGS. 1 to 6.

Referring to FIG. 9, when receiving a read request from the host 2000, the memory system 1000 may perform a read operation. For example, during the read operation, the host 2000 may transmit an external read command and a logical address to the memory system 1000 at step S81. Here, the external read command and the logical address may be received through the host interface 240 of the memory system 1000.

The logical address included in the read request may be converted into a physical address in the internal memory 210 of the memory controller 1200 at step S82. For example, during the read operation, when the host 2000 transmits the logical address to the memory system 1000, a physical address corresponding to the logical address may be selected from among the physical addresses stored in the mapping table of the internal memory 210.

The control processor 200 of the memory controller 1200 may convert the external read command received from the host 2000 into an internal read command to be used in the memory system 1000, and may transmit the internal read command and the physical address to a memory device 100 through the memory interface 220 at step S83. The memory device 100 may be selected in response to the physical address. The selected memory device 100 may perform the read operation in response to the internal read command and the physical address at step S84.

Data (i.e., read data) read from the selected memory device 100 may be received to the memory interface 220 of the memory controller 1200 and directly transmitted to the host interface 240 through the bus 250 of the memory controller 1200 at step S85. In other words, when the read data outputted from the selected memory device 100 is received to the memory controller 1200, the read data may be directly transmitted to the host interface 240 without being temporarily stored in the buffer memory 230. Therefore, during the read operation, the operation of temporarily storing the read data in the buffer memory 230 may be skipped, whereby the read operation time may be reduced.

Moreover, the read data received in the memory controller 1200 may be converted into a form appropriate to the type of the host 2000 before being outputted to the host 2000. The foregoing conversion operation may be performed in the control process 200.

The read data transmitted to the host interface 240 may be sequentially outputted to the host 2000 at step S86. When the read data is converted into a form appropriate to the type of the host 2000, the converted data may be outputted to the host 2000.

The sequence of the operation steps S81 to S86 of the memory controller 1200 will be described below with reference to the drawing illustrating the memory system.

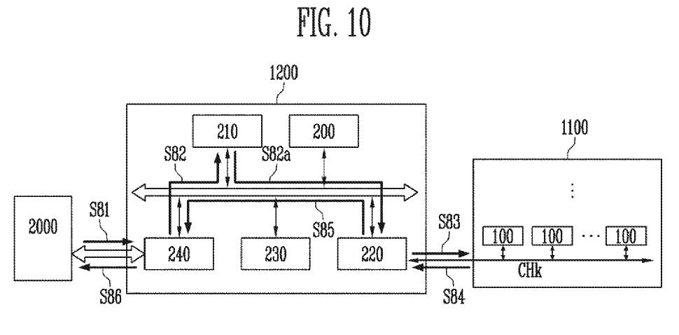

FIG. 10 is a diagram illustrating the sequence of the read operation of FIG. 9.

Referring to FIGS. 9 and 10, when receiving a read request from the host 2000, the memory system 1000 may perform a read operation. For example, during the read operation, the host 2000 may transmit an external read command and a logical address to the memory system 1000 at step S81. Here, the external read command and the logical address may be received through the host interface 240 of the memory system 1000.

The logical address included in the read request may be converted into a physical address in the internal memory 210 of the memory controller 1200 at step S82. For example, during the read operation, when the host 2000 transmits the logical address to the memory system 1000, a physical address corresponding to the logical address may be selected from among the physical addresses stored in the mapping table of the internal memory 210.

The control processor 200 of the memory controller 1200 may convert the external read command received from the host 2000 into an internal read command to be used in the memory system 1000, and may transmit the internal read command and the physical address to the memory device 100 through the memory interface 220 at step S83. The selected memory device 100 may perform the read operation in response to the internal read command and the physical address at step S84.

When read data from the selected memory device 100 is received in the memory interface 220 of the memory controller 1200 at step S84, the read data may be directly transmitted to the host interface 240 through the bus 250 of the memory controller 1200 at step S85. In other words, when the read data outputted from the selected memory device 100 is received in the memory controller 1200, the read data may be directly transmitted to the host interface 240 without being temporarily stored in the buffer memory 230. Therefore, during the read operation, the operation of temporarily storing the read data in the buffer memory 230 may be skipped, whereby the read operation time may be reduced.

The read data transmitted to the host interface 240 may be sequentially outputted to the host 2000 at step S86. For example, the control process 200 may control the host interface 240 so that the read data transmitted to the host interface 240 is outputted to the host 2000 in response to a clock.

In other words, when receiving the read data from the memory device 100, the memory controller 1200 may directly output the read data to the host through the host interface 240 without performing the operating of temporarily storing the read operation in the buffer memory 230. Consequently, the read operation time may be reduced.

Furthermore, because in lieu of the read data other data may be stored in the buffer memory 230 of the memory controller 1200, the buffer memory 230 may be used for a purpose similar to that of the internal memory 210. Therefore, the lack of capacity in the internal memory 210 included in the memory controller 1200 may be compensated.

FIG. 11 is a diagram illustrating an embodiment of a memory system 30000 including the memory controller 1200 shown in FIG. 1.

Referring to FIG. 11, the memory system 30000 may be embodied in a cellular phone, a smartphone, a tablet PC, a personal digital assistant (PDA) or a wireless communication device. The memory system 30000 may include the storage device 1100 and the memory controller 1200 capable of controlling the operation of the storage device 1100. The memory controller 1200 may control a data access operation, e.g., a program operation, an erase operation, or a read operation, of the storage device 1100 under control of a processor 3100. As described above, during a read operation, the memory controller 1200 may directly output read data from the storage device 1100 to the processor 3100 without going through the buffer memory. Hence, the read operation time may be reduced.

Data programmed in the storage device 1100 may be outputted through a display 3200 under control of the memory controller 1200.

A radio transceiver 3300 may send and receive radio signals through an antenna ANT. For example, the radio transceiver 3300 may change a radio signal received through the antenna ANT into a signal which may be processed in the processor 3100. Therefore, the processor 3100 may process a signal outputted from the radio transceiver 3300 and transmit the processed signal to the memory controller 1200 or the display 3200. The memory controller 1200 may transmit a signal processed by the processor 3100 to the storage device 1100. Furthermore, the radio transceiver 3300 may change a signal outputted from the processor 3100 into a radio signal, and output the changed radio signal to an external device through the antenna ANT. An input device 3400 may be used to input a control signal for controlling the operation of the processor 3100 or data to be processed by the processor 3100. The input device 3400 may be embodied by a pointing device such as a touch pad and a computer mouse, a keypad or a keyboard. The processor 3100 may control the operation of the display 3200 such that data outputted from the memory controller 1200, data outputted from the radio transceiver 3300, or data outputted form the input device 3400 is outputted through the display 3200.

In an embodiment, the memory controller 1200 capable of controlling the operation of the storage device 1100 may be embodied as a part of the processor 3100 or a chip provided separately from the processor 3100.

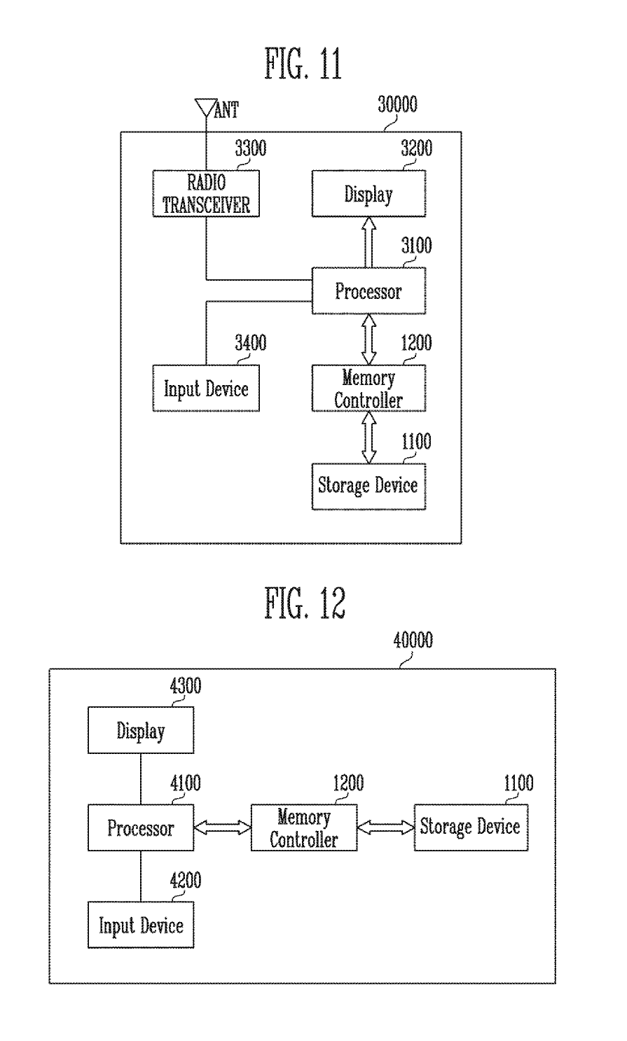

FIG. 12 is a diagram illustrating an embodiment of a memory system 40000 including the memory controller 1200 shown in FIG. 1.

Referring to FIG. 12, the memory system 40000 may be embodied in a personal computer (PC), a tablet PC, a net-book, an e-reader, a personal digital assistant (PDA), a portable multimedia player (PMP), an MP3 player, or an MP4 player.

The memory system 40000 may include the storage device 1100 and the memory controller 1200 capable of controlling the data processing operation of the storage device 1100.

A processor 4100 may output data stored in the storage device 1100 through a display 4300, according to data inputted by an input device 4200. For example, the input device 4200 may be embodied by a pointing device such as a touch pad or a computer mouse, a keypad or a keyboard.

The processor 4100 may control the overall operation of the memory system 40000 and control the operation of the memory controller 1200. In an embodiment, the memory controller 1200 capable of controlling the operation of the storage device 1100 may be embodied as a part of the processor 4100 or a chip provided separately from the processor 4100.

Particularly, during a read operation, the memory controller 1200 may directly output read data to the processor 4100 without performing an operation of storing the read data in the buffer memory, whereby the read operation time may be reduced.

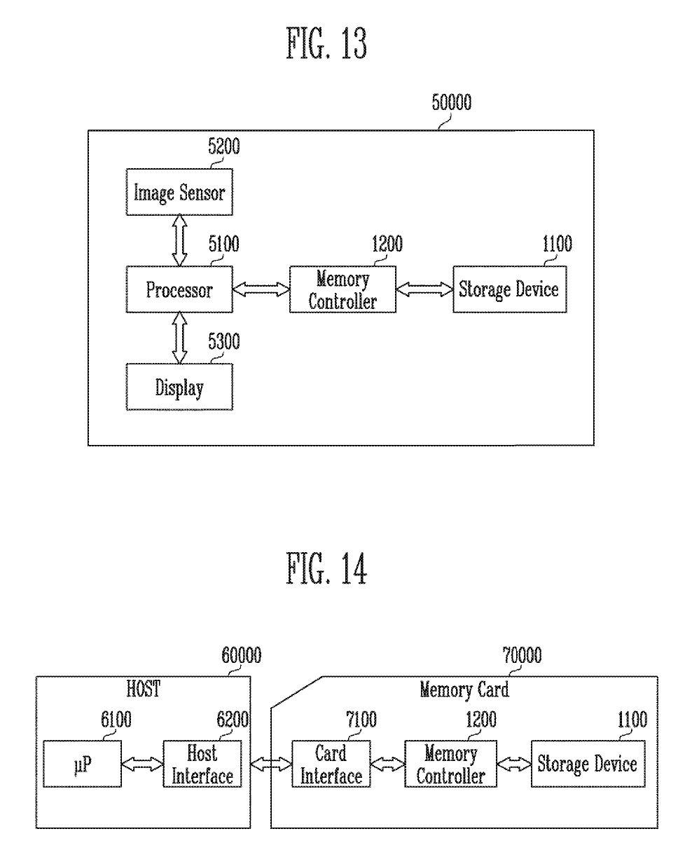

FIG. 13 is a diagram illustrating an embodiment of a memory system 50000 including the memory controller 1200 shown in FIG. 1.

Referring to FIG. 13, the memory system 50000 may be embodied in an image processing device, e.g., a digital camera, a portable phone provided with a digital camera, a smartphone provided with a digital camera, or a tablet PC provided with a digital camera.

The memory system 50000 may include the storage device 1100 and the memory controller 1200 capable of controlling a data processing operation, e.g., a program operation, an erase operation, or a read operation, of the storage device 1100.

An image sensor 5200 of the memory system 50000 may convert an optical image into digital signals. The converted digital signals may be transmitted to a processor 5100 or the memory controller 1200. Under control of the processor 5100, the converted digital signals may be outputted through a display 5300 or stored in the storage device 1100 through the memory controller 1200. Data stored in the storage device 1100 may be outputted through the display 5300 under control of the processor 5100 or the memory controller 1200.

In an embodiment, the memory controller 1200 capable of controlling the operation of the storage device 1100 may be embodied as a part of the processor 5100 or a chip provided separately from the processor 5100.

Particularly, during a read operation, the memory controller 1200 may directly output read data to the processor 5100 without performing an operation of storing the read data in the buffer memory, whereby the read operation time may be reduced.

FIG. 14 is a diagram illustrating an embodiment of a memory system 70000 including the memory controller 1200 shown in FIG. 1.

Referring to FIG. 14, the memory system 70000 may be embodied in a memory card or a smart card. The memory system 70000 may include the storage device 1100, the memory controller 1200, and a card interface 7100.

The memory controller 1200 may control data exchange between the storage device 1100 and the card interface 7100. In an embodiment, the card interface 7100 may be a secure digital (SD) card interface or a multi-media card (MMC) interface, but it is not limited thereto. Particularly, during a read operation, the memory controller 1200 may directly output read data to the card interface 7100 without performing an operation of storing the read data in the buffer memory, whereby the read operation time may be reduced.

The card interface 7100 may interface data exchange between a host 60000 and the memory controller 1200 according to a protocol of the host 60000. In an embodiment, the card interface 7100 may support a universal serial bus (USB) protocol, and an inter-chip (IC)-USB protocol. Here, the card interface 7100 may refer to hardware capable of supporting a protocol which is used by the host 60000, software installed in the hardware, or a signal transmission method.

When the memory system 70000 is connected to a host interface 6200 of the host 60000 such as a PC, a tablet PC, a digital camera, a digital audio player, a cellular phone, console video game hardware or a digital set-top box, the host interface 6200 may perform data communication with the storage device 1100 through the card interface 7100 and the memory controller 1200 under control of a microprocessor 6100.

Various embodiments of the present disclosure may reduce the read operation time and compensating for lack of memory capacity.

Examples of embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A memory controller comprising:
a host interface configured to receive an external read command and a logical address from a host, and output read data to the host;
an internal memory configured to output a physical address corresponding to the logical address;
a control processor configured to convert the external read command into an internal read command, and control a read operation; and
a memory interface configured to transmit the internal read address and the physical address to a memory device, and transmit read data received from the memory device to the host interface.

2. The memory controller according to claim 1, wherein the host interface, the internal memory, the control processor, and the host interface transmit the external read command, the internal read command, the logical address, the physical address, the read data to each other through a bus.

3. The memory controller according to claim 1, further comprising a buffer memory configured to temporarily store data received from the host during a program operation.

4. The memory controller according to claim 3, wherein the buffer memory does not store the read data during the read operation.

5. The memory controller according to claim 1, wherein the internal memory includes a plurality of mapping tables configured to store information about the logical address and the physical address.

6. The memory controller according to claim 5, wherein, according to the plurality of mapping tables, the internal memory converts the logical address into the physical address during a program operation, and converts the physical address into the logical address during the read operation.

7. The memory controller according to claim 1, wherein the control processor controls the host interface, the internal memory, and the memory interface during the read operation or a program operation.

8. The memory controller according to claim 1, wherein the control processor controls the memory interface and the host interface such that:
the read data is received from the memory device through the memory interface during the read operation;
the read data received to the memory interface is transmitted to the host interface; and
the read data transmitted to the host interface is outputted to the host.

9. The memory controller according to claim 1, wherein the control processor controls the host interface such that the read data transmitted to the host interface is outputted to the host in response to a clock.

10. A memory system comprising:
a memory device configured to store data; and
a memory controller configured to read, during a read operation, data stored in the memory device and output the read data to a host without temporarily storing the read data in the memory system.

11. The memory system according to claim 10, wherein the memory device is formed of a non-volatile memory device or a volatile memory device.

12. The memory system according to claim 10, wherein the memory controller controls an operation of communicating a command, an address, and data between the host and the memory device.

13. The memory system according to claim 10, wherein when a read request is received from the host, the memory controller generates an internal read command and a physical address, transmits the internal read command and the physical address to the memory device, receives read data from the memory device, and directly transmits the read data to the host without performing an operation of storing the read data.

14. The memory system according to claim 13, wherein the host transmits an external read command and a logical address to the memory controller.

15. The memory system according to claim 14, wherein the memory controller converts the external read command into the internal read command, and converts the logical address into the physical address.

16. A method of operating a memory system, comprising:
receiving a read request from a host;
controlling a memory device to perform a read operation in response to the read request;
receiving read data from the memory device; and
directly outputting the read data to the host without storing the read data in the memory system.

17. The method according to claim 16, wherein the read request includes an external read command and a logical address.

18. The method according to claim 17, wherein the controlling of the memory device to perform the read operation comprises:
converting the external read command into an internal read command;
converting the logical address into a physical address;
transmitting the internal read command and the physical address to the memory device; and
performing the read operation on the memory device in response to the internal read command and the physical address.

19. The method according to claim 16, wherein the directly outputting of the read data to the host comprises:
receiving the read data through a memory interface;
transmitting the read data from the memory interface to a host interface; and
outputting the read data transmitted to the host interface, to the host.

20. The method according to claim 19, wherein in the transmitting of the read data to the host interface, the read data is directly transmitted to the host interface without being stored in a buffer memory.
